(19) United States
(12) Patent Application Publication
(10) Pub. No.: US 2005/0279578 A1
(43) Pub. Date: Dec. 22, 2005

(54) Grease zerk dust cap

(76) Inventor: Jay Aaron Stadeli, Silverton, OR (US)

Correspondence Address: Jay Stadeli, 615 W. Main, Silverton, OR, 97381, US

(21) Appl. No.: 10/656,590

(22) Filed: Sep. 8, 2003

(51) Int. Cl. F16N 13/22; F16N 19/00

(52) U.S. Cl. 184/88.1

(57) ABSTRACT

A grease zerk cover comprised of a single piece has an opening to accept a grease zerk, a retaining lip inside the opening, a flare on the end with the opening to scrape residual grease from the zerk when the cap is affixed to the zerk, and a flare on the opposite end providing a gripping surface for the fingers of the hand to remove it.

### REFERENCES TO RELATED APPLICATIONS

There are no references to related applications.

### STATEMENTS OF FEDERAL SPONSORSHIP

There are no statements of federal sponsorship.

### REFERENCES TO “SEQUENCE LISTINGS”

There are no references to sequence listings.

### BACKGROUND OF THE INVENTION

The field of this invention includes agricultural, industrial, and automotive industries, and any other application where grease zerks are utilized.

Grease zerks are used to periodically lubricate a component such as a bearing, bushing or shaft. The zerk is fastened to the component with a threaded base which screws into the component. A tool commonly known as a grease gun is affixed to the zerk and grease is forced through the zerk into the component. When the grease gun is removed, residual grease is left on the zerk. During operation of the machine, airborne particles accumulate on the residual grease on the zerk. Before the next lubrication, a person must carefully wipe the accumulated matter from the zerk before greasing. If this is not done, the matter which has accumulated on the zerk is injected into the component and damages it. In some cases, high-velocity particles continually strike the zerk, wearing metal from it. This prevents effective greasing because the grease leaks past the worn area instead of being injected into the component through the zerk. Grit also accumulates around the check ball area in the zerk and is very difficult to remove. Often this grit is injected directly into the component during greasing. The presence of water is another reason to keep a grease zerk protected. Water leads to rust on the zerk and the check ball inside it, causing the zerk to leak grease back out of the component during machinery operation. These problems are the reason I have devised the grease zerk dust cap.

### PRIOR ART

There is no known prior art.

### SUMMARY OF THE INVENTION

The grease zerk dust cap is a protective cover affixed to a grease zerk to keep it free of unwanted matter and protect it from adverse operating conditions as described previously.

### DESCRIPTION OF DRAWINGS

Figure one depicts the invention as a side view, where reference number one denotes the removal flare end of the cover. Reference number two indicates the scraper flare end of the cover.

Figure two shows a side view cutaway, where reference numbers one and two are the same as previously stated, and reference number three indicating the opening to accept a grease zerk. Reference number four indicates the retaining lip which fits into the neck of the grease fitting.

### DETAILED DESCRIPTION OF THE INVENTION

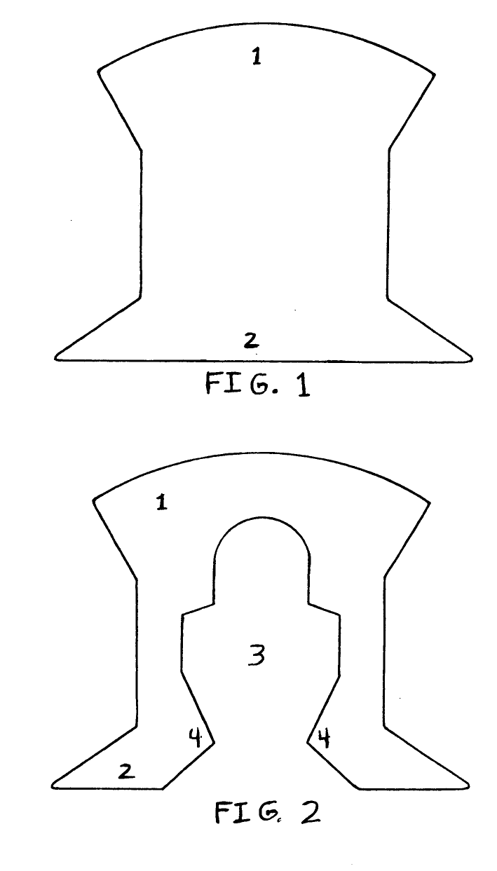

The grease zerk dust cap is a protective cover for a grease zerk to keep it free of unwanted matter. It is composed of a flexible material that is resistant to various chemicals, heat, cold and ultraviolet radiation. It is a single piece unit with two opposing ends, each end having a flare. The end with the larger flare has a bore to accept a grease zerk. Inside the bore is a retaining surface to prevent the cap from becoming dislodged from the zerk due to centrifugal force, such as on a rotating shaft. The retaining surface rests in the neck of the zerk. The flare on the end of the cap having the bore scrapes residual grease from the zerk when it is affixed to the zerk after greasing. On the remaining end of the cap is a domed flare. This flare provides a quick and convenient way to grip and remove the cap with the fingers of the human hand. FIG. 1 shows a grease zerk dust cap in its entirety, in the form of a side view cutaway.

1. A grease zerk cover, comprised of a single piece with two opposing ends, said cover having various outside diameters, with the diameter of said ends significantly larger than the diameter of said cover between said ends, one of the ends having an opening which extends into said cover, said opening having various diameters as it extends into said cover.

2. The device of claim one, where said ends taper consistently, each beginning at a specific location on the length of said cover, to a specific larger diameter, which is the actual end of said cover, with respect to the portion of said cover between the beginning of the taper of said ends, said portion between ends being cylindrical and unchanging in diameter.

3. The device of claim one, where the inside diameter of said opening decreases in the form of a consistent taper as it extends into said cover until it reaches a specific inside diameter, then increases in the form of a consistent taper to a specific inside diameter as it further extends into said cover, where the diameter continues unchanged for a specific length into said cover, where it is then decreased to a specific diameter, which continues for a specific length into said cover, where said opening then ends.

4. The device of claim one, where the end opposite the end having the opening is slightly domed.
